(19) United States
(12) Patent Application Publication
(10) Pub. No.: US 2025/0361771 A1
(43) Pub. Date: Nov. 27, 2025

(54) INTELLIGENT LADDER

(71) Applicant: SHENZHEN HAIGE CROSS BORDER TECHNOLOGY CO., LTD., Shenzhen (CN)

(72) Inventor: Yunhang Yang, Shenzhen (CN)

(73) Assignee: SHENZHEN HAIGE CROSS BORDER TECHNOLOGY CO., LTD., Shenzhen (CN)

(21) Appl. No.: 18/731,960

(22) Filed: Jun. 3, 2024

(30) Foreign Application Priority Data
May 23, 2024 (CN) 202410653221.2

(51) Int. Cl. E06C 7/00; E06C 1/20; E06C 7/42

(52) U.S. Cl. CPC E06C 7/003; E06C 7/42; E06C 1/20

(57) ABSTRACT

The present invention relates to an intelligent ladder, including a ladder frame, at least one pressure sensor, and a display module. The pressure sensor is installed at a bottom of the ladder frame, the pressure sensor is configured to detect a gravity change of the ladder frame, and the display module is connected to the pressure sensor electrically or by using a wireless signal. Because the pressure sensor is installed at the bottom of the ladder frame, the pressure sensor is used to detect the gravity change of the ladder frame, that is, detect a load condition of the ladder frame. The pressure sensor transmits obtained load data to the display module, and the display module presents the load data to a user for observation, so that the user confirms a state of the ladder frame in real time.

### CROSS REFERENCE TO RELATED APPLICATION

This application claims priority to Chinese Application No.: CN202410653221.2 filed May 23, 2024 which application is incorporated herein by reference in their entirety.

### TECHNICAL FIELD

The present invention relates to the technical field of ladders, and in particular, to an intelligent ladder.

### BACKGROUND

Ladders are mainly used to provide people with access to high places. However, each ladder has a load-bearing limit. If a weight borne by the ladder exceeds a load limit of the ladder when the ladder is used, the ladder may be easily damaged or may easily collapse. These situations may cause serious injury to a user and another nearby person.

An existing ladder cannot show a current load condition of the ladder for a user, and it is difficult to determine a state of the ladder in real time when the user climbs the ladder with a load.

### SUMMARY

In view of this, the present invention provides an intelligent ladder, to resolve a problem that a ladder in the conventional technology cannot show a current load condition of the ladder.

To achieve one or some or all of the foregoing objectives or another objective, the present invention provides
an intelligent ladder, including:
a ladder frame;
at least one pressure sensor, where the at least one pressure sensor is installed at a bottom of the ladder frame, and the at least one pressure sensor is configured to detect a gravity change of the ladder frame; and
a display module, where the display module is connected to the at least one pressure sensor electrically or by using a wireless signal, and the display module is configured to display the gravity change of the ladder frame.

Preferably, the intelligent ladder further includes at least one force-bearing member, the at least one force-bearing member is installed at the bottom of the ladder frame, the at least one force-bearing member is configured to contact the ground, and the at least one force-bearing member presses against the at least one pressure sensor.

Preferably, the force-bearing member includes a contact member and a load-bearing abutment post, the contact member is installed at the bottom of the ladder frame, the contact member is configured to contact the ground, the contact member is elastically deformable, the load-bearing abutment post is inserted into the contact member, the load-bearing abutment post presses against a bottom of the pressure sensor, and the load-bearing abutment post is capable of fluctuating up and down with elastic deformation of the contact member.

Preferably, an installation groove is disposed at the bottom of the ladder frame, the pressure sensor is embedded in the installation groove, the contact member covers the installation groove, and the contact member presses against the bottom of the pressure sensor.

Preferably, a first connection part is disposed at the bottom of the ladder frame, a second connection part is disposed on a peripheral side of the contact member, and the first connection part and the second connection part are fixedly connected by using a bolt.

Preferably, a contact boss is disposed at a bottom of the contact member, a bottom surface of the contact boss is designed in an arc shape, and the load-bearing abutment post extends to be distributed in the contact boss.

Preferably, a sounding unit is further disposed on the display module.

Preferably, at least three support legs are disposed at the bottom of the ladder frame, and the pressure sensor is installed at a bottom of any support leg.

Preferably, a quantity of pressure sensors is the same as a quantity of support legs, and the pressure sensor is installed at the bottom of each support leg.

Preferably, the display module is detachably installed on the ladder frame, a wire passing channel is disposed inside the ladder frame, the wire passing channel extends downward from a top of the ladder frame and is connected to the installation groove, the pressure sensor is electrically connected to the display module by using a wire, and the wire passes through the wire passing channel.

The following beneficial effects are achieved by implementing the embodiments of the present invention:

After the intelligent ladder is used, because the pressure sensor is installed at the bottom of the ladder frame, the pressure sensor is used to detect the gravity change of the ladder frame, that is, detect a load condition of the ladder frame. The pressure sensor transmits obtained load data to the display module, and the display module presents the load data to a user for observation, so that the user confirms a state of the ladder frame in real time.

### BRIEF DESCRIPTION OF DRAWINGS

To describe the technical solutions in the embodiments of the present invention or the conventional technology more clearly, the following briefly describes the accompanying drawings required for describing the embodiments or the conventional technology. Apparently, the accompanying drawings in the following description are merely some embodiments of the present invention, and a person of ordinary skill in the art may still derive other accompanying drawings from these accompanying drawings without creative efforts.

FIG. 1 is a schematic diagram 1 of an overall structure according to an embodiment;

FIG. 2 is a schematic diagram of an exploded assembly structure of a support leg according to an embodiment;

FIG. 3 is an enlarged view of a part A in FIG. 2;

FIG. 4 is a schematic diagram of a structure of a force-bearing member according to an embodiment;

FIG. 5 is a schematic diagram of a cross-sectional structure of a support leg according to an embodiment;

FIG. 6 is a schematic diagram 2 of an overall structure according to an embodiment;

FIG. 7 is an enlarged view of a part B in FIG. 6;

FIG. 8 is a schematic diagram of a distribution structure of wires according to an embodiment;

FIG. 9 is a schematic diagram of a connection structure of a sounding unit, an information processing unit, pressure sensors, and a display module according to an embodiment; and

FIG. 10 is a schematic diagram of a connection structure of a sounding unit, an information processing unit, pressure sensors, and a display module according to another embodiment;

where:
ladder: 1; installation groove: 11; first connection part: 12; support leg: 13; wire passing channel: 14; first support frame: 101; second support frame: 102; pedal group: 103; first rod body: 1011; second rod body: 1021; cross rod: 1022;
pressure sensor: 2;
display module: 3; clamping boss: 31;
force-bearing member: 4; contact member: 41; load-bearing abutment post: 42; second connection part: 411; contact boss: 412; and
wire: 5.

### DESCRIPTION OF EMBODIMENTS

Unless otherwise defined, all technical and scientific terms used herein have the same meanings as those usually understood by a person skilled in the technical field of the present invention. The terms used herein in the applied specification are merely intended to describe specific embodiments, and are not intended to limit the present invention. The terms “include” and “have” and any modification thereof in the specification, the claims, and the brief description of the drawings of the present invention are intended to cover non-exclusive inclusion. The terms “first”, “second”, and the like in the specification, the claims, or the accompanying drawings of the present invention are used to distinguish between different objects, and are not used to describe a specific sequence.

Referring to an “embodiment” herein means that a specific feature, structure, or characteristic described with reference to the embodiment may be included in at least one embodiment of the present invention. That the phrase appears at various positions in the specification does not necessarily refer to a same embodiment, nor is it a separate or alternative embodiment mutually exclusive with another embodiment. A person skilled in the art explicitly and implicitly understands that the embodiments described in the specification may be combined with another embodiment.

To enable a person skilled in the art to better understand the solutions of the present invention, the following clearly describes the technical solutions in the embodiments of the present invention with reference to the accompanying drawings.

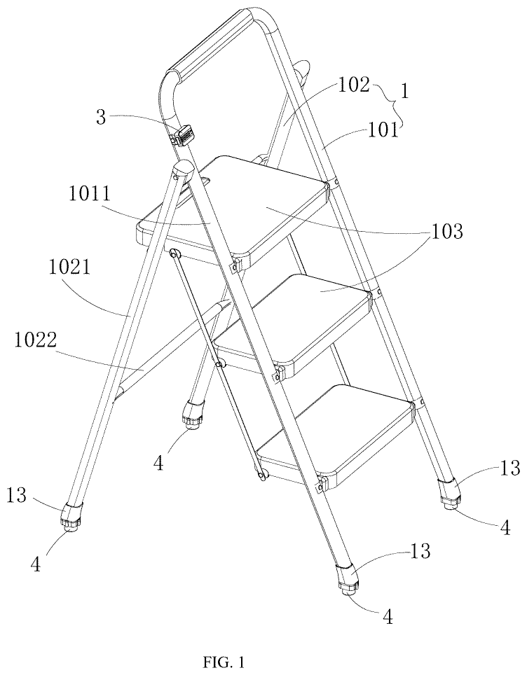

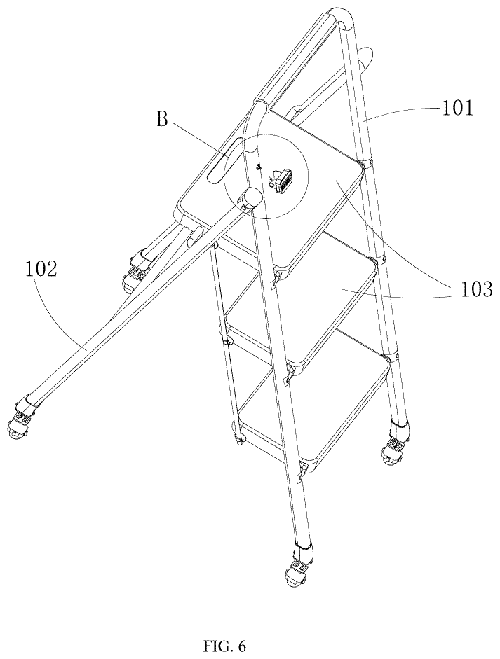

Refer to FIG. 1 to FIG. 8. The present invention provides an intelligent ladder, including a ladder frame 1, a pressure sensor 2, and a display module 3. The pressure sensor 2 detects a load condition of the ladder frame 1, and the display module 3 presents the load condition to a user.

Specifically, the ladder frame 1 is used for climbing by the user, and there is at least one pressure sensor 2. The pressure sensor 2 is installed at a bottom of the ladder frame 1, and the pressure sensor 2 is configured to detect a gravity change of the ladder frame 1.

In this embodiment, the display module 3 is installed on the ladder frame 1, the display module 3 has a display screen, the display module 3 is electrically connected to the pressure sensor 2 by using a wire 5, and a battery is disposed on the display module 3. In this embodiment, the display module 3 is integrated on the ladder frame 1, to prevent the user from missing the display module 3.

In another embodiment, the display module 3 may be disposed completely independent of the ladder frame 1, a built-in battery is disposed in each of the display module 3 and the pressure sensor 2, and the display module 3 is connected to the pressure sensor 2 by using a wireless signal, for example, is connected by using Bluetooth.

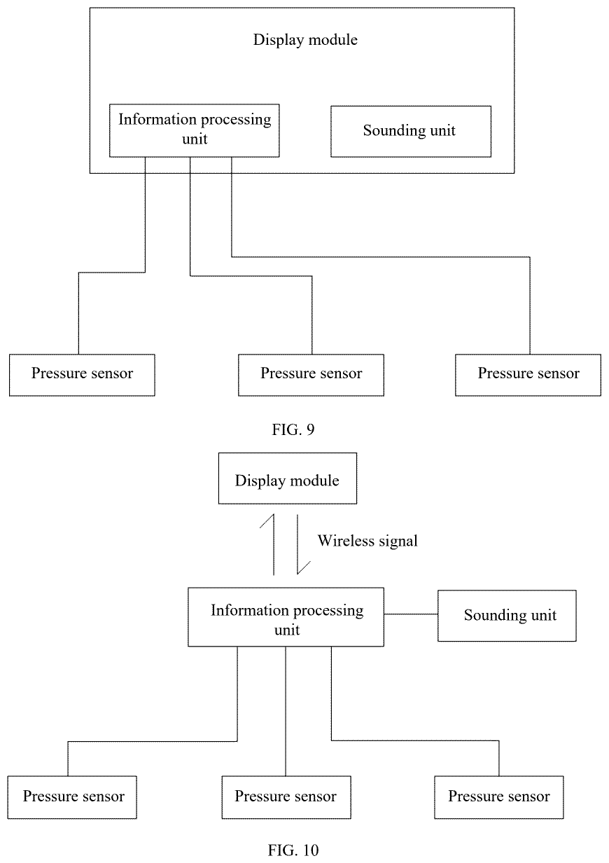

In addition, the intelligent ladder further has an information processing unit. The information processing unit is configured to process information obtained by the pressure sensor 2. The information processing unit may be integrated on the pressure sensor 2, disposed on the ladder frame 1, or disposed on the display module 3. As shown in FIG. 9, the information processing unit is disposed on the display module 3.

Specifically, because the pressure sensor 2 is installed at the bottom of the ladder frame 1, the pressure sensor 2 is used to detect the gravity change of the ladder frame 1, that is, detect the load condition of the ladder frame 1. The pressure sensor 2 transmits obtained load data to the display module 3, and the display module 3 presents the load data to the user for observation, so that the user confirms a state of the ladder frame 1 in real time.

In this embodiment, the pressure sensor 2 is specifically a straingauge-type transducer.

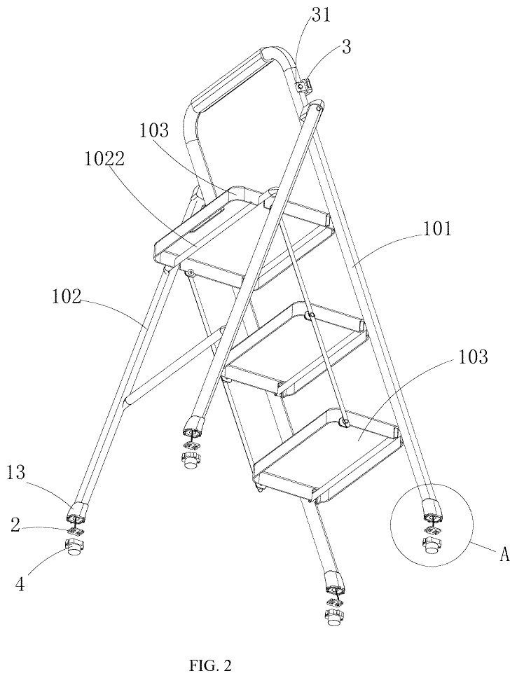

In a preferred embodiment, as shown in FIG. 2, the intelligent ladder further includes at least one force-bearing member 4, the at least one force-bearing member 4 is installed at the bottom of the ladder frame 1, the force-bearing member 4 is configured to contact the ground, the force-bearing member 4 may be elastically deformed, and the at least one force-bearing member 4 presses against the at least one pressure sensor 2. The force-bearing member 4 is supported on the ground. When the ladder frame 1 is loaded, the force-bearing member 4 is deformed and compresses the pressure sensor 2. The pressure sensor 2 obtains the load data based on a received compressive force. In another embodiment, a slidable telescopic rod may be further disposed at the bottom of the ladder frame 1, and the pressure sensor 2 is disposed at a top of the telescopic rod. When the telescopic rod presses against the ground, the telescopic rod compresses the pressure sensor 2.

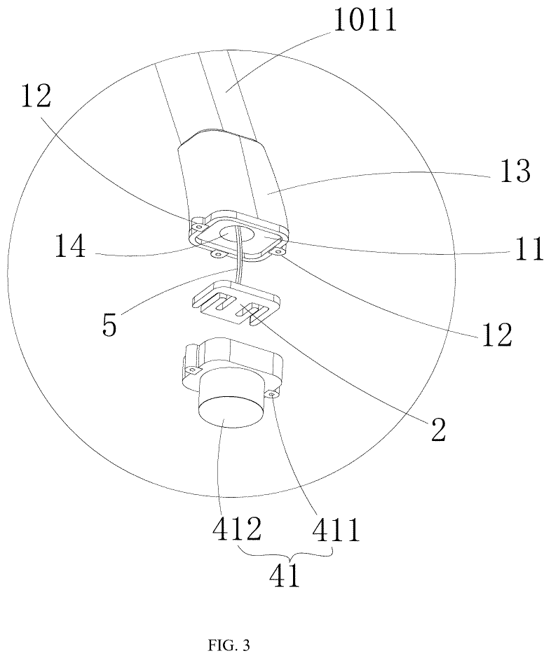

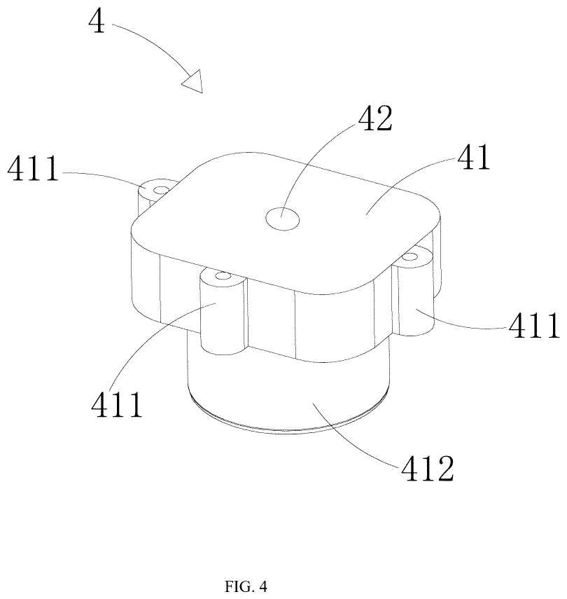

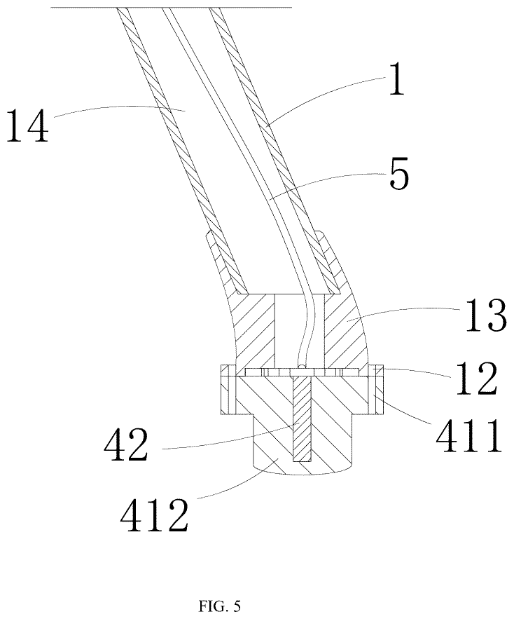

For a specific disposition structure of the force-bearing member 4, in a preferred embodiment, as shown in FIG. 3, FIG. 4, and FIG. 5, the force-bearing member 4 includes a contact member 41 and a load-bearing abutment post 42, the contact member 41 is installed at the bottom of the ladder frame 1, the contact member 41 is configured to contact the ground, the contact member 41 may be elastically deformed, the load-bearing abutment post 42 is vertically inserted into the contact member 41, the load-bearing abutment post 42 presses against a bottom surface of the pressure sensor 2, the load-bearing abutment post 42 is capable of fluctuating up and down with elastic deformation of the contact member 41, and a fluctuating degree of the load-bearing abutment post 42 corresponds to a magnitude of pressure received by the pressure sensor 2. A contact boss 412 is disposed at a bottom of the contact member 41, and a bottom surface of the contact boss 412 is designed in an arc shape, so that a centermost part of the contact boss 412 contacts the ground, and the load-bearing abutment post 42 extends to be distributed in the contact boss 412. When the contact boss 412 presses against the ground, a load of the ladder frame 1 enables the contact boss 412 to have a trend of moving in a direction toward the ground. However, because of a counter force exerted by the ground against the contact boss 412, a center position of the contact boss 412 is correspondingly compressed upward and elastically deformed, so that the load-bearing abutment post 42 is pushed up relative to the contact member 41, that is, the load-bearing abutment post 42 presses upward against the pressure sensor 2. In this case, the pressure sensor 2 measures the magnitude of the received pressure based on a deformation degree of the contact boss 412, and performs corresponding conversion to obtain the load data of the ladder frame 1. The bottom surface of the contact boss 412 is designed in the arc shape, so that a force-bearing point of the contact boss 412 is the center position. In this way, pressure generated when the contact boss 412 is deformed can be transmitted to the load-bearing abutment post 42 more precisely.

In a preferred embodiment, the contact member 41 is made of a rubber material, so that the contact member is more easily deformed. The load-bearing abutment post 42 is made of a metal material, and the load-bearing abutment post 42 may be specifically a steel post, a copper post, or the like, so that strength of the load-bearing abutment post is higher, and a pressure exertion result for the pressure sensor is more accurate.

Further, as shown in FIG. 3, an installation groove 11 is disposed at the bottom of the ladder frame 1, the pressure sensor 2 is embedded in the installation groove 11, the contact member 41 is installed below the installation groove 11, the contact member 41 is used to cover the installation groove 11 and the pressure sensor 2 in the installation groove 11, and the contact member presses against the bottom of the pressure sensor. When the bottom of the contact member is compressed and deformed, the load-bearing abutment post protrudes upward and is higher than a top surface of the contact member. In this case, pressure exerted by the load-bearing abutment post on the pressure sensor indicates the load condition of the ladder frame.

Specifically, a first connection part 12 is disposed at the bottom of the ladder frame 1, a second connection part 411 is disposed on a peripheral side of the contact member 41, a hole is disposed on each of the first connection part 12 and the second connection part 411, and the first connection part 12 and the second connection part 411 are connected by using a bolt and are tightly locked.

Further, to enable the intelligent ladder to inform the user of the load condition of the intelligent ladder, in a preferred embodiment, a sounding unit is disposed on the display module 3, and the sounding unit is a horn. When the pressure sensor 2 detects that the ladder frame 1 is loaded, the display module 3 learns of information and makes a voice prompt through the horn. In this embodiment, a connection structure of the sounding unit, the information processing unit, the pressure sensors, and the display module is shown in FIG. 9.

In another embodiment, the sounding unit may alternatively be disposed on the ladder frame 1, the sounding unit is electrically connected to the pressure sensor 2, and the sounding unit is a buzzer. When the pressure sensor 2 detects that the ladder frame 1 is overloaded, the sounding unit gives an alarm tone. In another embodiment, a connection structure of the sounding unit, the information processing unit, the pressure sensors, and the display module is shown in FIG. 10.

Further, in an embodiment, the ladder frame 1 is designed as a folding ladder structure. Specifically, the ladder frame 1 includes a first support frame 101 and a second support frame 102. A top of the first support frame 101 is hinged to a top of the second support frame 102, at least two support legs 13 are disposed at a bottom of the first support frame 101, and at least one support leg 13 is disposed at a bottom of the second support frame 102. The at least one pressure sensor 2 is installed at a bottom of any support leg 13. That is, the foldable ladder frame 1 may be in a ladder shape such as a three-legged ladder, a four-legged ladder, a six-legged ladder, or an eight-legged ladder. The pressure sensor 2 may be installed on any support leg 13 to implement an objective of load detection.

Certainly, to make a detection result more accurate, in a preferred embodiment, a plurality of pressure sensors 2 are disposed, and a quantity of pressure sensors 2 is the same as a quantity of support legs 13, and the pressure sensor 2 is installed at the bottom of each support leg 13. The installation groove 11 is correspondingly disposed at the bottom of each of the support legs 13, and the force-bearing member 4 is installed at the bottom of each of the support legs 13. Data collected by the pressure sensors 2 is centralized in the information processing unit for conversion processing, and a conversion form is similar to an electronic scale. Accurate data obtained after the information processing unit performs conversion processing is sent to the display module 3, and the display screen presents the data.

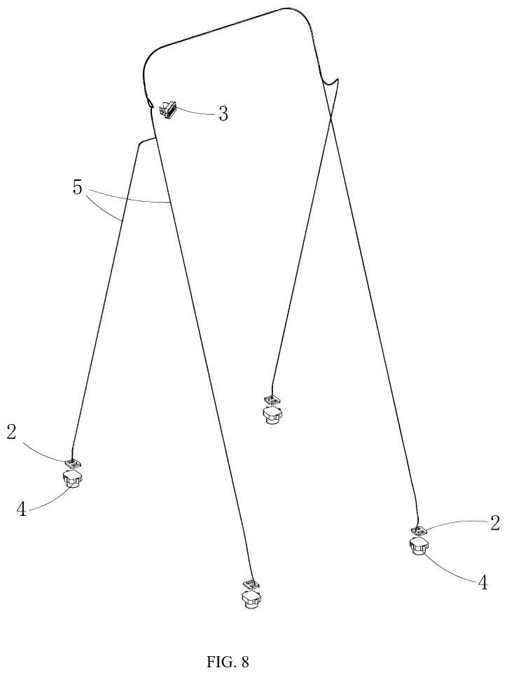

In addition, the embodiment in which a display is installed on the ladder frame 1 is specifically as follows: The display module 3 is installed on the first support frame 101 by using a clamping mechanism, the first support frame 101 and the second support frame 102 each are hollowed out to form a wire passing channel 14, the wire passing channel 14 extends downward and is connected to the installation groove 11, the pressure sensor 2 is electrically connected to the display module 3 by using the wire 5, the wire 5 passes through the wire passing channel 14, and the wire 5 inside the second support frame 102 may extend out from the top of the second support frame 102 to be connected to the display module 3. Alternatively, the wire 5 inside the second support frame 102 may pass through a hinge shaft between the second support frame 102 and the first support frame 101, and extend into the first support frame 101 to converge with the wire 5 inside the first support frame 101, so that the wires 5 together are connected to the display module 3. A distribution structure of the wires 5 is shown in FIG. 8.

In addition, as shown in FIG. 1, the first support frame 101 includes two first rod bodies 1011 and a pedal group 103 rotatably disposed between the two first rod bodies 1011, and a bottom of each first rod body 1011 is the support leg 13. The second support frame 102 includes two second rod bodies 1021 and a cross rod 1022 connecting the two second rod bodies 1021, and a bottom of each second rod body 1021 is also the support leg 13. The pedal group 103 may be lapped over the cross rod 1022 after being unfolded, and is configured to provide a standable plane for the user.

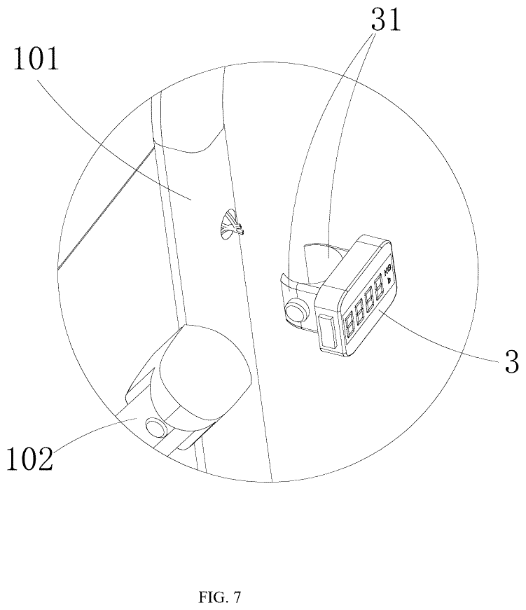

The clamping mechanism used by the display module 3 is specifically as follows: As shown in FIG. 7, two clamping bosses 31 are disposed on a back side of the display module 3, the two clamping bosses 31 respectively press against two side surfaces of one of the first rod bodies 1011, and the two clamping bosses 31 are connected by using a bolt, so that the two clamping bosses 31 together can tightly clamp the first rod body 1011 by screwing the bolt. The display module 3 is installed by using the clamping mechanism, to adjust a position of the display module 3, thereby adapting to usage habits of different users.

Apparently, the foregoing described embodiments are merely some rather than all of the embodiments of the present invention. The accompanying drawings provide preferred embodiments of the present invention, but are not intended to limit the patent scope of the present invention. The present invention may be implemented in many different forms. On the contrary, these embodiments are provided to provide a more thorough understanding of the disclosed content of the present invention. Although the present invention is described in detail with reference to the foregoing embodiments, a person skilled in the art may still modify the technical solutions described in the foregoing specific implementations, or perform equivalent replacement on some of the technical features. All equivalent structures that are made based on the content in the specification and the accompanying drawings of the present invention and that are directly or indirectly applied to other related technical fields also fall within the patent protection scope of the present invention.

What is claimed is:

1. An intelligent ladder, comprising:
a ladder frame;
at least one pressure sensor, wherein the at least one pressure sensor is installed at a bottom of the ladder frame, and the at least one pressure sensor is configured to detect a gravity change of the ladder frame; and
a display module, wherein the display module is connected to the at least one pressure sensor electrically or by using a wireless signal, and the display module is configured to display the gravity change of the ladder frame.

2. The intelligent ladder according to claim 1, wherein the intelligent ladder further comprises at least one force-bearing member, the at least one force-bearing member is installed at the bottom of the ladder frame, the at least one force-bearing member is configured to contact the ground, and the at least one force-bearing member presses against the at least one pressure sensor.

3. The intelligent ladder according to claim 2, wherein the force-bearing member comprises a contact member and a load-bearing abutment post, the contact member is installed at the bottom of the ladder frame, the contact member is configured to contact the ground, the contact member is elastically deformable, the load-bearing abutment post is inserted into the contact member, the load-bearing abutment post presses against a bottom of the at least one pressure sensor, and the load-bearing abutment post is capable of fluctuating up and down with elastic deformation of the contact member.

4. The intelligent ladder according to claim 3, wherein an installation groove is disposed at the bottom of the ladder frame, the pressure sensor is embedded in the installation groove, the contact member covers the installation groove, and the contact member presses against the bottom of the at least one pressure sensor.

5. The intelligent ladder according to claim 3, wherein a first connection part is disposed at the bottom of the ladder frame, a second connection part is disposed on a peripheral side of the contact member, and the first connection part and the second connection part are fixedly connected by using a bolt.

6. The intelligent ladder according to claim 3, wherein a contact boss is disposed at a bottom of the contact member, a bottom surface of the contact boss is designed in an arc shape, and the load-bearing abutment post extends to be distributed in the contact boss.

7. The intelligent ladder according to claim 1, wherein a sounding unit is further disposed on the display module.

8. The intelligent ladder according to claim 1, wherein at least three support legs are disposed at the bottom of the ladder frame, and the pressure sensor is installed at a bottom of any support leg.

9. The intelligent ladder according to claim 8, wherein a quantity of pressure sensors is the same as a quantity of support legs, and the pressure sensor is installed at the bottom of each support leg.

10. The intelligent ladder according to claim 4, wherein the display module is detachably installed on the ladder frame, a wire passing channel is disposed inside the ladder frame, the wire passing channel extends downward from a top of the ladder frame and is connected to the installation groove, the pressure sensor is electrically connected to the display module by using a wire, and the wire passes through the wire passing channel.
